(19) United States
(12) Patent Application Publication
(10) Pub. No.: US 2020/0363226 A1
(43) Pub. Date: Nov. 19, 2020

(54) SERVER APPARATUS, METHOD, AND STORAGE MEDIUM

(71) Applicant: HONDA MOTOR CO., LTD., Tokyo (JP)

(72) Inventor: Manabu ICHIKAWA, Wako-shi (JP)

(21) Appl. No.: 16/988,012

(22) Filed: Aug. 7, 2020

Related U.S. Application Data
(63) Continuation of application No. PCT/JP2018/045205, filed on Dec. 10, 2018.

(30) Foreign Application Priority Data
Feb. 15, 2018 (JP) 2018-025339

(51) Int. Cl. G01C 21/34; G01C 21/36; G06Q 10/06

(52) U.S. Cl. CPC G01C 21/3476; H02J 7/0042; G06Q 10/06315; G01C 21/3679

(57) ABSTRACT

The present invention provides a server apparatus for transmitting information for requesting support to an information terminal mounted in a moving object, the apparatus comprising: a management unit configured to manage a plurality of pieces of information each including a support location; a reception unit configured to receive current position information of the moving object from the information terminal; a selection unit configured to select, based on the current position information received by the reception unit, among the plurality of pieces of information, information indicating that a positional relationship between a current position of the moving object and the support location satisfies a predetermined condition; and a transmission unit configured to transmit the information selected by the selection unit to the information terminal.

### CROSS-REFERENCE TO RELATED APPLICATIONS

This application is a continuation of International Patent Application No. PCT/JP2018/045205 filed on Dec. 10, 2018, which claims priority to and the benefit of Japanese Patent Application No. 2018-025339 filed on Feb. 15, 2018, the entire disclosures of which are incorporated herein by reference.

### BACKGROUND OF THE INVENTION

### Field of the Invention

The present invention relates to a server apparatus, a method, and a storage medium which perform information transmission to an information terminal.

### Background Art

PTL 1 proposes an apparatus for notifying the presence of a tourist spot when a user searches for the tourist spot midway along a route until a destination set by the user.

In an area such as a depopulated area where problems such as a decrease in logistics efficiency and the lack of manpower have occurred, a local government actually secures a lot of budget to solve the above problems. In order to reduce the load of a local government or the like and solve the above problems, support is preferably asked for delivery or help to a moving object (a vehicle occupant or the like) passing near such an area.

The present invention has as its object to transmit appropriate information among a plurality of pieces of information.

### CITATION LIST

### Patent Literature

PTL 1: Japanese Patent Laid-Open No. 2017-194317

### SUMMARY OF THE INVENTION

According to the present invention, there is provided a server apparatus for transmitting information for requesting support to an information terminal mounted in a moving object, the apparatus comprising: a management unit configured to manage a plurality of pieces of information each including a support location; a reception unit configured to receive current position information of the moving object from the information terminal; a selection unit configured to select, based on the current position information received by the reception unit, among the plurality of pieces of information, information indicating that a positional relationship between a current position of the moving object and the support location satisfies a predetermined condition; and a transmission unit configured to transmit the information selected by the selection unit to the information terminal, wherein the reception unit further receives, from the information terminal, remaining amount information of a battery mounted in the moving object, and wherein the selection unit selects, as the predetermined condition, among the plurality of pieces of information, information satisfying a condition in which the support location is present in a range of a possible moving distance of the moving object estimated from the remaining amount information.

Further features of the present invention will become apparent from the following description of exemplary embodiments with reference to the attached drawings.

### BRIEF DESCRIPTION OF THE DRAWINGS

FIG. 1 is a block diagram showing the overall arrangement of a support request system;

FIG. 2A is a block diagram showing the arrangement of an in-vehicle device;

FIG. 2B is a block diagram showing the arrangement of a server;

FIG. 3 is a table showing an example of a plurality of pieces of support request information:

FIG. 4 is a sequence chart showing processing performed between the in-vehicle device, the server, and each support requester;

FIG. 5 is a flowchart showing support request processing;

FIG. 6 is a flowchart showing an example of processing for processing support request information which satisfies a predetermined condition;

FIG. 7 is a schematic view for explaining an example of processing for searching for the support request information which satisfies the predetermined condition;

FIG. 8 is a flowchart showing an example of the processing for searching for the support request information which satisfies the predetermined condition;

FIG. 9 is a schematic view for explaining an example of processing for searching for the support request information which satisfies the predetermined condition;

FIG. 10A is a view showing an example of a screen of support request information displayed on a display unit; and

FIG. 10B is a view showing an example of a screen of support request information displayed on the display unit.

### DESCRIPTION OF THE EMBODIMENTS

The embodiment of the present invention will now be described with reference to the accompanying drawings. The present invention is not limited to the following embodiments, and includes changes and modifications of arrangements within the scope of the present invention. In addition, not all the combinations of features described in the embodiments are necessarily essential to the present invention. In the following embodiment, an example in which information is transmitted to an in-vehicle device serving as an information terminal will be described. However, the information terminal is not limited to the in-vehicle device, but may be, for example, a mobile phone (smartphone). A moving object to which the information terminal is applied (mounted or held) is not limited to a vehicle (for example, a four-wheeled vehicle or a straddle type vehicle), but may be a bicycle or a human. The following embodiment will exemplify an example in which support request information satisfying a predetermined condition among a plurality of pieces of support request information is transmitted to the information terminal (in-vehicle device) and the support is requested to the information terminal. Information managed by the server apparatus and transmitted to the information terminal is not limited to the support request information, but can be information other than the support request information.

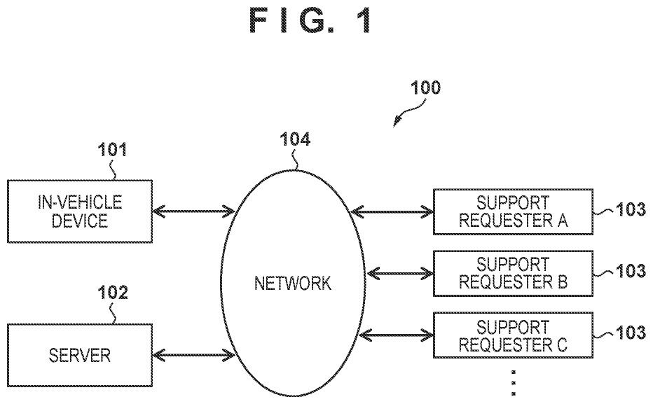

FIG. 1 is a block diagram showing the overall arrangement of a support request system 100 according to an embodiment of the present invention. As shown in FIG. 1, the support request system 100 according to this embodiment includes an in-vehicle device 101, a server 102, and a plurality of support requesters 103. The in-vehicle device 101, the server 102, and each support requester 103 (more specifically, a mobile terminal or computer arranged in each support requester 103) are communicably arranged via a network 104 and can exchange information (data).

The in-vehicle device 101 is mounted in a vehicle. In this embodiment, as a vehicle on which the in-vehicle device 101 is mounted, a motor-driven straddle type vehicle (for example, a two-wheeled vehicle) will be exemplified. The server 102 can become a computer capable of executing the present invention according to the program. In addition, the support requester 103 includes a person who requests support, a local government (an area), or a company and can include, for example, a person or local government that requests support (help) such as agricultural help or shopping, a company (a courier) that requests support of delivery to a specific area, and the like. In the example shown in FIG. 1, support requesters A to C are shown as the support requesters 103. However, the number of support requesters 103 is not limited to three, but can be two or four or more.

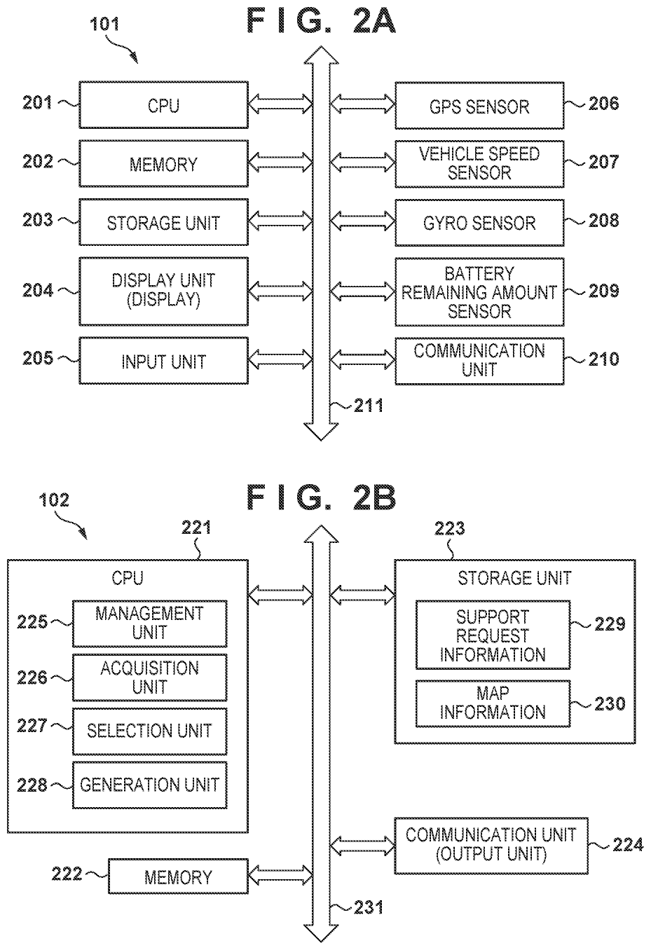

FIG. 2A is a block diagram showing the arrangement of the in-vehicle device 101. The respective blocks shown in FIG. 2A are communicably connected via a system bus 211. A CPU 201 comprehensively controls the in-vehicle device 101 by causing the CPU 201 to read out a program stored in a storage unit 203 to a memory 202 and execute the program. The storage unit 203 can store, for example, information input or set by an occupant (for example, a driver) via an input unit 205 in addition to the basic programs and data for operating the in-vehicle device 101. A communication unit 210 serves as an interface capable of performing communication with the network 104 and can exchange information with the server 102 via the network 104.

A display unit 204 gives alarm information to the vehicle occupant by image display. The input unit 205 accepts information input from the vehicle occupant. In this embodiment, a display such as a touch panel LCD (Liquid Crystal Display) is used. The touch panel LCD functions as both the display unit 204 and the input unit 205. However, the arrangement is not limited to this. The input unit 205 (for example, a keyboard) may be arranged independently of the display as the display unit 204.

A GPS sensor 206 detects the current position of the vehicle. A vehicle speed sensor 207 detects the current speed of the vehicle. A gyro sensor 208 detects the rotation motion of the vehicle. The CPU 201 determines the course of the vehicle based on the detection results of these sensors. In addition, in this embodiment, since the electric vehicle is used as a vehicle, the in-vehicle device 101 includes a battery remaining amount sensor 209 for detecting the remaining amount of the battery of the electric vehicle. The CPU 201 estimates (calculates) a possible traveling distance of the vehicle based on the battery remaining amount detected by the battery remaining amount sensor 209.

FIG. 2B is a block diagram showing the arrangement of the server 102. The respective blocks shown in FIG. 2B are communicably connected via a system bus 231. A CPU 221 comprehensively controls the server 102 by causing the CPU 221 to read out, for example, a program stored in a storage unit 223 to a memory 222 and execute the program. In addition, a communication unit 224 (an output unit) serves as an interface capable of performing communication with the network 104 and can exchange information with the in-vehicle device 101 and each support requester 103 via the network 104. The storage unit 223 can store, for example, support request information 229 received from each support requester 103, map information 230 received by the communication unit 224 via the network 104, and the like in addition to the basic programs and data for operating the server 102.

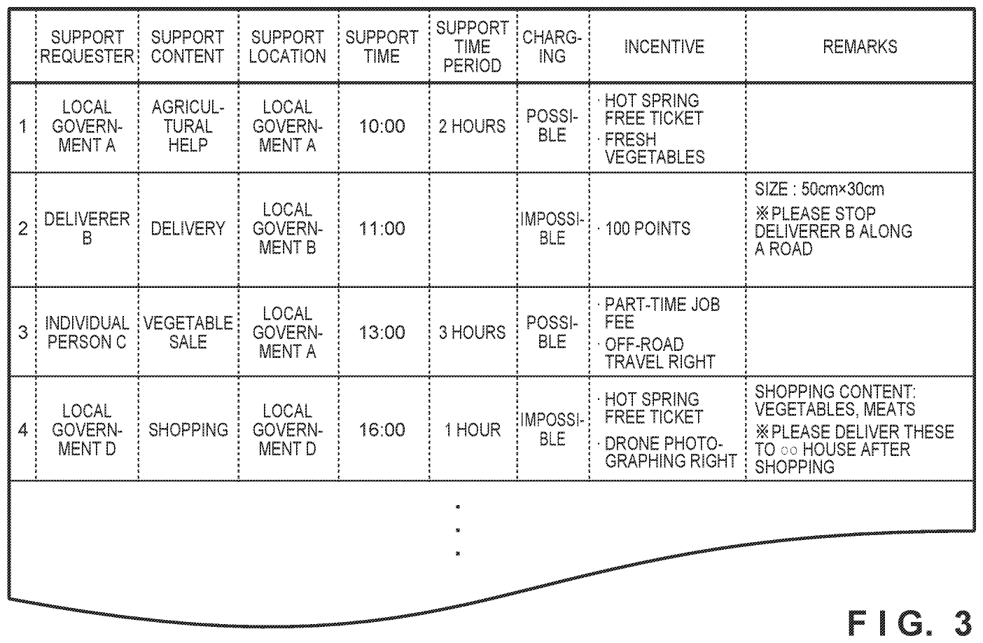

The support request information 229 is information indicating the contents of support requested from each support requester 103 and received from the computer or the like of each support requester 103 by the communication unit 224 via the network 104. FIG. 3 is a table showing an example of the plurality of pieces of support request information 229 received from each support requester 103 via the network 104 and stored in the storage unit 223. The support request information 229 can include information such as a support requester, the contents of support, a support location, support start time (desired start time of the support), and support time period (scheduled time period over which support is to be performed). In addition, the support request information 229 can include information indicating whether a charging facility (a charging station) capable of charging the electric vehicle is present in a support location, information (incentive information) concerning the incentive supplied when support is executed, information (remark information) to be noticed when support is to be performed, and the like.

The map information 230 is information indicating the position of each support requester 103, the position of the support location, and the road of each support requester 103 and can be received by the communication unit 224 via the network 104. The map information 230 may include congestion information estimated from a past tendency in consideration of the day of the week, the season, and the weather, traffic information such as a construction and a road closure, and the like.

In addition, the CPU 221 of the server 102 can include a management unit 225, an acquisition unit 226, a selection unit 227, and a generation unit 228. The management unit 225 manages the plurality of pieces of support request information 229 stored in the storage unit 223. For example, the management unit 225 can cause the storage unit 223 to store the support request information 229 received from each support requester 103 by the communication unit 224, acquires the support request information 229 stored in the storage unit 223, and transmit the support request information 229 selected by the selection unit 227 to the in-vehicle device 101 via the communication unit 224. The acquisition unit 226 acquires (receives) the information concerning the vehicle from the in-vehicle device 101 via the communication unit 224. The selection unit 227 selects the support request information 229 satisfying a predetermined condition among the plurality of pieces of support request information 229 stored in the storage unit 223. The generation unit 228 generates route information up to the support location.

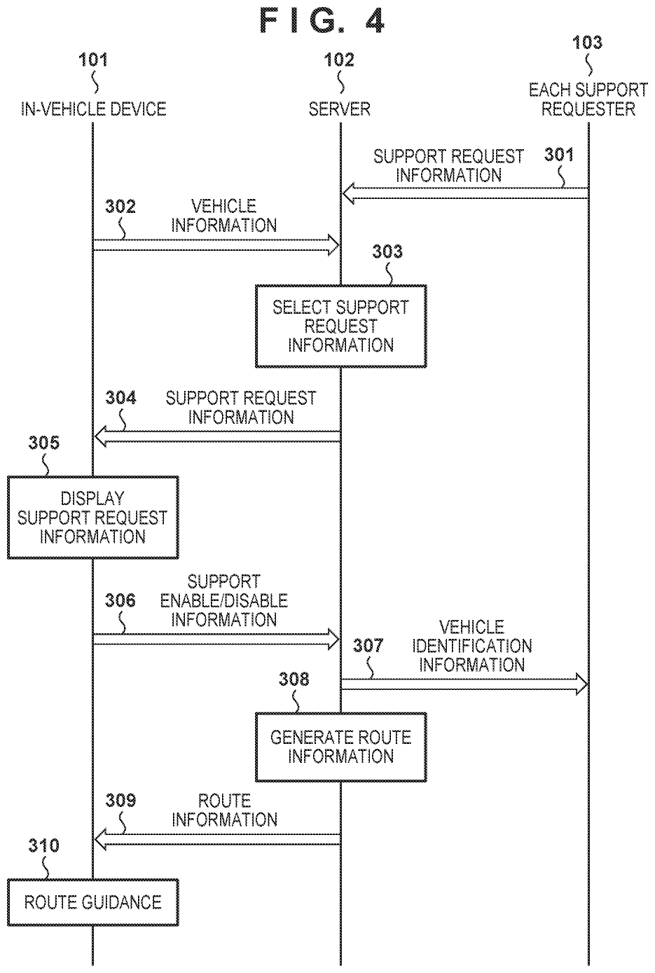

Next, processing performed between the in-vehicle device 101, the server 102, and each support requester 103 in the support request system 100 shown in FIG. 1 will be described with reference to FIG. 4. FIG. 4 is a sequence chart showing processing between the in-vehicle device 101, the server 102, and each support requester 103. In step 301, the computer of each support requester 103 or the like sequentially transmits support request information to the server 102 via the network 104. The support request information received from each support requester 103 is stored in the storage unit 223 of the server 102. In step 302, the vehicle information is transmitted from the in-vehicle device 101 to the server 102 via the network 104.

Upon reception of the vehicle information, the server 102 selects the support request information satisfying the predetermined condition among the plurality of pieces of support request information stored in the storage unit 223 (step 303). Details of a method of selecting the support request information will be described later. If the support request information satisfying the predetermined condition is selected in the server 102, the selected support request information is transmitted to the in-vehicle device 101 (step 304), and the transmitted support request information is displayed on the display unit 204 of the in-vehicle device 101 (step 305). If the information (support enable/disable information) indicating whether the support request is supported is input to the input unit 205 by the user, the in-vehicle device 101 transmits the support enable/disable information to the server 102 via the network 104 (step 306). If the support enable/disable information indicates that the support is possible, the server 102 transmits, via the network 104, to the support requester 103 of the support request information selected in step 303, the identification information of the vehicle for which the support is possible (step 307). In addition, the server 102 generates a route up to the support location of the support request information selected in step 303 (step 308), and transmits the generated route information to the in-vehicle device 101 via the network 104 (step 309). Accordingly, the in-vehicle device 101 can start the route guidance to the user in accordance with the route information acquired from the server (step 310).

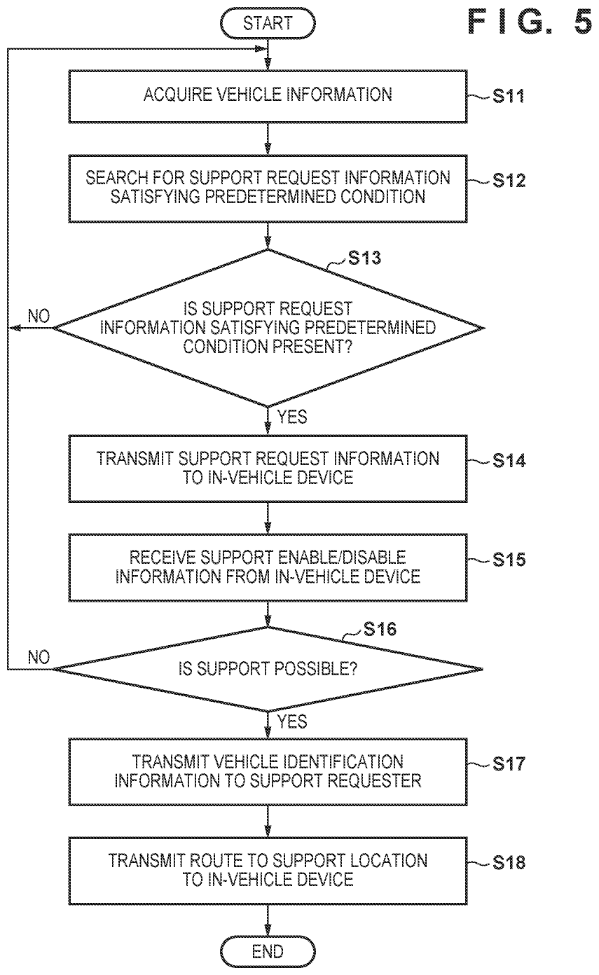

Next, the support request processing performed in the server 102 will be described with reference to FIG. 5. FIG. 5 is a flowchart showing the support request processing performed in the server 102. In the following description, the processing shown in FIG. 5 will be explained by executing an example by the CPU 221 of the server 102.

In S11, the CPU 221 acquires (receives) information concerning the vehicle (to be also referred to as vehicle information hereinafter) from the in-vehicle device 101 via the network 104 by the communication unit 224. The vehicle information can include the identification information (for example, information concerning a vehicle model, a color, a number plate number, and an occupant) for identifying the vehicle. This identification information may be registered in advance by the occupant via the computer of the input unit 205 or the occupant and stored in the storage unit 223 of the server 102. In addition, the vehicle information can include, for example, information (current position information) indicating the current position of the vehicle of the user calculated from the detection results of the GPS sensor 206, the vehicle speed sensor 207, and the gyro sensor 208 of the in-vehicle device 101 and information (battery remaining amount information) indicating the remaining amount of the battery detected by the battery remaining amount sensor 209 of the in-vehicle device 101. In addition, the user vehicle information may include information concerning the characteristics (performance) of the vehicle of the user, such as the capacity and charging rate of the battery and the fuel consumption (traveling distance per unit power).

In S12, based on the vehicle information acquired by the in-vehicle device 101, the CPU 221 searches for the support request information 229 in which the relationship between the current position of the vehicle and the support location satisfies a predetermined condition, among the plurality of pieces of support request information 229 stored in the storage unit 223. That is, the CPU 221 searches for the information concerning the location (the support location) in which the positional relationship with the vehicle serving as the moving object satisfies a predetermined condition. As the predetermined condition, for example, a condition in which a traveling distance (a moving distance) from the current position of the vehicle to the support location is equal to or less than a predetermined distance (threshold) or a condition in which a traveling time (a moving time) from the current position of the vehicle to the support location is equal to or less than a predetermined time (threshold) can be used. The predetermined distance and the predetermined time can be set in advance in the server 102 as a traveling distance and traveling time such that the vehicle can reach the support location from the current position within about several ten minutes. In addition, based on the battery remaining amount information and vehicle characteristic information acquired from the in-vehicle device 101, the CPU 221 may estimate (calculate) a possible traveling distance at which the vehicle can travel with the battery remaining amount and use the estimated possible traveling distance as the predetermined distance. That is, the CPU 221 can use, as the predetermined condition, a condition in which the traveling distance from the current position of the vehicle to the support location is equal to or less than the possible traveling distance estimated from the battery remaining amount information and the like.

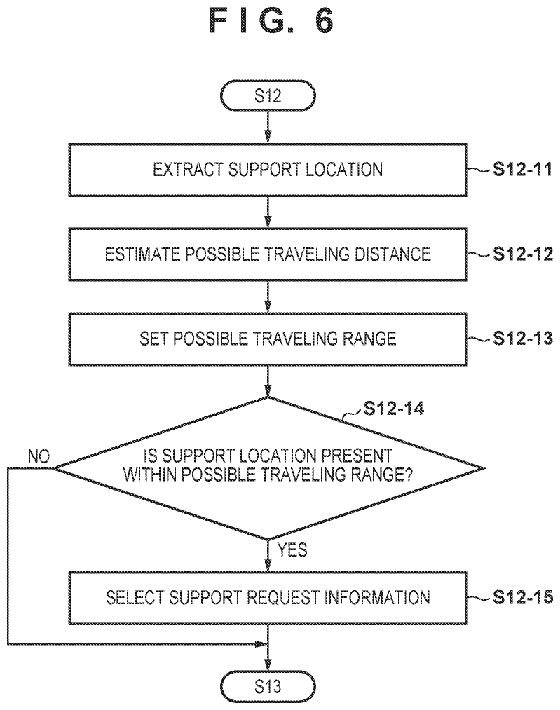

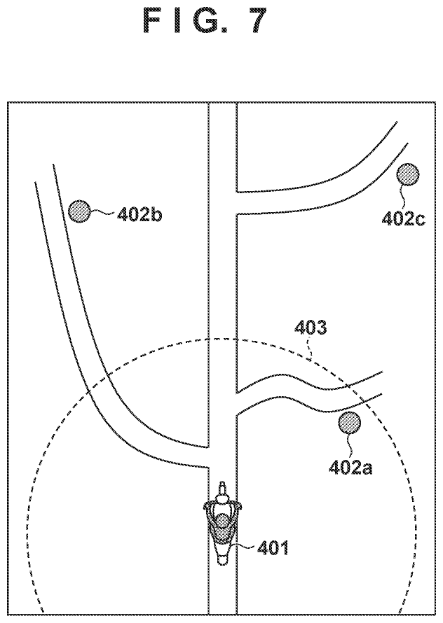

FIGS. 6 and 7 are views showing an example of processing of S12 for searching for the support request information 229 satisfying the predetermined condition. FIG. 6 is a flowchart showing the processing for searching for the support request information 229 satisfying the predetermined condition, and FIG. 7 is a conceptual view for explaining the processing. FIGS. 6 and 7 show the example in which a condition in which the traveling distance from the current position to the support location is equal to or less than the possible traveling distance estimated from the battery remaining amount information and the like is used as the predetermined condition.

In S12-11, the CPU 221 extracts (decides) the support location from each of the plurality of pieces of support request information 229 stored in the storage unit 223. In S12-12, based on the vehicle information acquired from the in-vehicle device 101, the CPU 221 estimates the possible traveling distance (a possible moving distance) at which the vehicle can travel with the battery remaining amount. In S12-13, based on the possible traveling distance estimated in S12-12 and the current position information of the vehicle, the CPU 221 sets the possible traveling range in which the vehicle can reach with the current battery remaining amount from the current position. In the example of FIG. 7, three support locations 402a to 402c extracted in S12-11 and a possible traveling range 403 of vehicle 401 set in S12-13 are shown.

The CPU 221 determines in S12-14 whether the support location is present within the possible traveling range set in S12-12. At this time, the CPU 221 may determine whether the support location having the charging station is present within the possible traveling range. Alternatively, the CPU 221 may determine whether the support location in which the vehicle can reach the support location until the support start time (the desired start time of the support) in the support request information 229 and the support can be started is present. If the support location is present within the possible traveling range, the process advances to S12-15. The CPU 221 selects the support request information 229 having the support location within the possible traveling range as the support request information satisfying the predetermined condition. In the example of FIG. 7, among the support locations 402a to 402c, the support location 402a is present within the possible traveling range 403 of the vehicle 401. In this case, the CPU 221 can select (decides) the support request information 229 having the support location 402a as the support request information satisfying the predetermined condition.

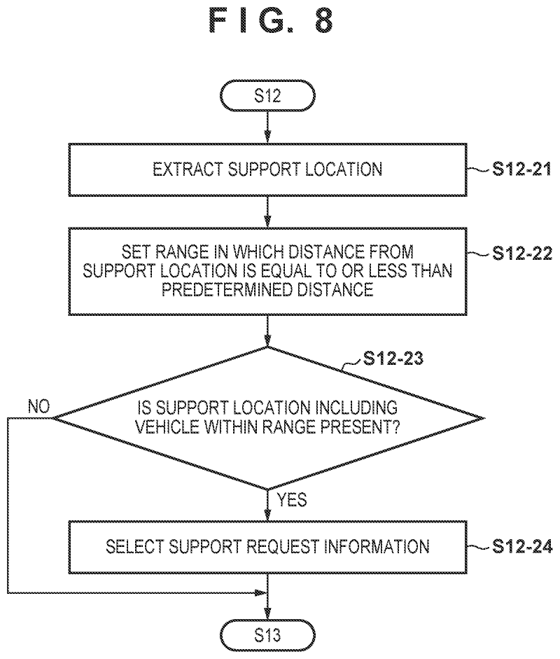

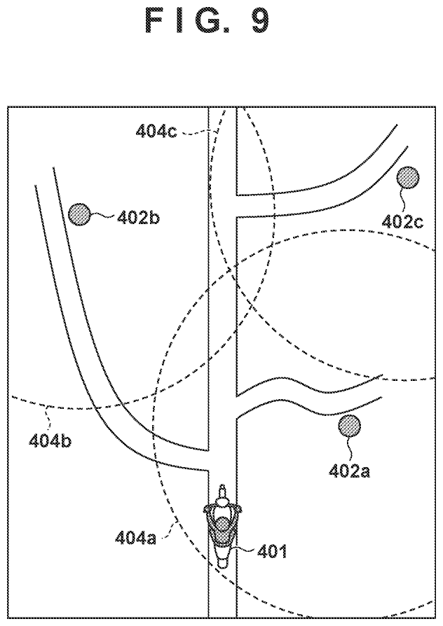

FIGS. 8 and 9 are views showing another example of processing of S12 for searching for the support request information 229 satisfying the predetermined condition. FIG. 8 is a flowchart showing the processing for searching for the support request information 229 satisfying the predetermined condition, and FIG. 9 is a conceptual view for explaining the processing. FIGS. 8 and 9 show the example in which a distance between the current position of the vehicle and the support location is equal to or less than a predetermined distance.

In S12-21, the CPU 221 extracts (decides) the support location from each of the plurality of pieces of support request information 229 stored in the storage unit 223. In S12-22, the CPU 221 sets a range in which a distance from the support location is equal to or less than the predetermined distance for each support location extracted in S12-21. In the example of FIG. 9, the support locations 402a to 402c extracted in S12-21 and ranges 404a to 404c respectively set for the support locations 402a to 402c in S12-22 are shown. In S12-23, the CPU 221 determines, based on the current position information of the vehicle, whether the support location including the vehicle within the range is present. If the support location including the vehicle within the range is present, the process advances to S12-24. The CPU 221 selects the support request information 229 having the support location as the support request information satisfying the predetermined condition. In the example of FIG. 9, the vehicle 401 is present within the range 404a of the support location 402a of the support locations 402a to 402c. In this case, the CPU 221 can select (decide) the support request information 229 having the support location 402a as the support request information satisfying the predetermined condition.

Referring back to the flowchart in FIG. 5, the CPU 221 determines in S13 whether the support request information 229 satisfying the predetermined condition is present among the plurality of pieces of support request information 229 stored in the storage unit 223. That is, the CPU 221 determines whether the support request information 229 is selected in the step of S12. If there is no the support request information 229 satisfying the predetermined condition, the process returns to S11, and the vehicle information is acquired again from the in-vehicle device 101. On the other hand, if there is the support request information 229 satisfying the predetermined condition, the process advances to S14.

In S14, the CPU 221 transmits (outputs) the support request information 229 satisfying the predetermined condition to the in-vehicle device 101 by the communication unit 224 via the network 104. At this time, in the in-vehicle device 101, the support request information 229 received by the communication unit 210 via the network 104 is displayed on the touch panel display functioning as the display unit 204 and the input unit 205.

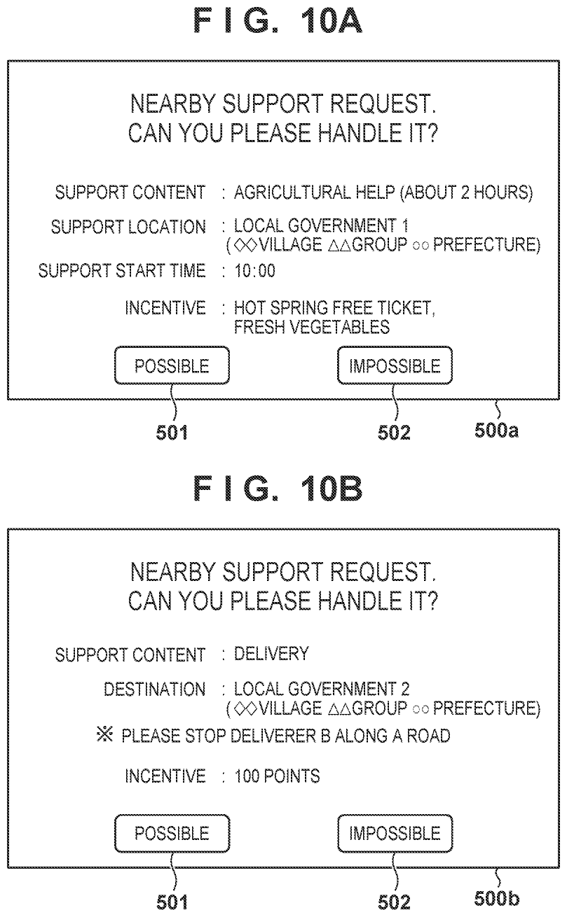

FIGS. 10A and 10B are views showing an example of screens of the support request information 229 displayed on the touch panel display. FIG. 10A shows the display example of a screen 500a of the support request information of a case 1 shown in FIG. 3, and FIG. 10B shows the display example of a screen 500b of the support request information of a case 2 shown in FIG. 3. In each of the screens 500a and 500b shown in FIGS. 10A and 10B, a “possible button 501” and an “impossible button 502” are arranged. The occupant of the vehicle presses the “possible button 501” if the occupant can cope with (can support) the support request information 229 displayed on the display unit 204, and presses the “impossible button 502” if the occupant cannot cope with (cannot support) the support request information 229. In this manner, if the occupant presses the “possible button 501” or the “impossible button 502”, the in-vehicle device 101 (CPU 201) transmits information (support enable/disable information) indicating whether the support is possible to the server 102 via the network 104 by the communication unit 210.

In S15, the CPU 221 receives the support enable/disable information from the in-vehicle device 101. In S16, the CPU 221 determines, based on the support enable/disable information received from the in-vehicle device 101, whether the support by the user is possible for the support request information 229 selected in S12. If the support by the user is impossible, processes in SI to S15 are performed again. On the other hand, if the support by the user is possible, the process advances to S17.

In S17, by the communication unit 224 via the network 104, the CPU 221 transmits the vehicle identification information acquired in S11 to a provider (that is, the support requester 103) of the support request information 229 selected in S12. Accordingly, the support requester 103 can know in advance information of a specific vehicle coming to the support location and information of a specific occupant coming to the support location. In addition, in S18, the CPU 221 generates (calculates) a route to the support location of the support request information 229 selected in S12 and transmits the generated route information to the in-vehicle device 101 via the network 104 by the communication unit 224. The in-vehicle unit 101 starts the route guidance in accordance with the received route information.

As has been described above, in the support request system 100 of this embodiment, among the plurality of pieces of support request information 229, the support request information 229 in which the relationship between the current position of the vehicle and the support location satisfies the predetermined condition is selected, and the selected support request information 229 is transmitted to the in-vehicle device 101. Accordingly, the occupant of the vehicle passing near the support request location can respond to the support request while heading to the destination. At the same time, the incentive can be obtained in correspondence with the support request. That is, the support request system 100 according to this embodiment is a system for promoting the positive support of the vehicle occupant for the request from the support requester 103. For example, this support request system 100 is applied to an area in which problems such as the decrease in logistics efficiency and the lack of manpower have occurred, thereby reducing the load of a local government or the like and solving the problems.

### Summary of Embodiment

A server apparatus according to this embodiment is a server apparatus (for example, 102) for transmitting information to an information terminal, comprising management means (for example, 225) for managing a plurality of pieces of information, reception means (for example, 224, 226) for receiving current position information of a moving object from the information terminal, selection means (for example, 227) for selecting, based on the current position information received by the reception means, information concerning a location where a positional relationship with the moving object satisfies a predetermined condition from the plurality of pieces of information, and transmission means (for example, 224) for transmitting the information selected by the selection means to the information terminal. With this arrangement, among the plurality of pieces of information, the information including the appropriate location with respect to the current position of the moving object can be transmitted to the information terminal. For example, the appropriate request can be made to the information terminal (the in-vehicle device) so that the moving object (for example, the vehicle occupant) passing near the support request location can respond to the support request while heading to the destination.

In addition, the selection means selects, as the predetermined condition, information concerning a location satisfying a condition in which a moving distance from the current position of the moving object is not more than a predetermined distance. With this arrangement, for example, the appropriate request can be made to the information terminal (the in-vehicle device) so that the moving object (for example, the vehicle occupant) passing near the support request location can respond to the support request while heading to the destination.

In addition, the selection means selects, as the predetermined condition, information concerning a location satisfying a condition in which a moving time from the current position of the moving object is not more than a predetermined time. With this arrangement, for example, the appropriate request can be made to the information terminal (the in-vehicle device) so that the moving object (for example, the vehicle occupant) passing near the support request location can respond to the support request while heading to the destination.

In addition, the reception means further receives, from the information terminal, remaining amount information of a battery mounted in the moving object, and the selection means selects, as the predetermined condition, information concerning a location satisfying a condition in which the moving object is present within a range of a possible moving distance of the moving object which is estimated from the remaining amount information. With this arrangement, for example, an appropriate support request is made to the information terminal (the in-vehicle device) so the dead battery or the like does not occur during traveling (moving) toward the support location.

In addition, the selection means selects information concerning a location having a charging station capable of charging the moving object. With this arrangement, for example, the appropriate request can be made to the information terminal (the in-vehicle device) so the dead battery or the like does not occur in the return path from the support location.

In addition, the management means manages, as the plurality of pieces of information, a plurality of pieces of support request information concerning a support request, and the selection means selects, from the plurality of pieces of support request information, based on the current position information received by the reception means, the support request information indicating that a relationship between the current position of the moving object and the support location satisfies a predetermined condition. With this arrangement, the moving object (the vehicle occupant or the like) passing near the support request location can make the appropriate support request to the information terminal (in-vehicle device) so as to respond to the support request while heading to the destination.

In addition, the selection means selects support request information in accordance with desired start time of a support request. With this arrangement, an appropriate support request can be made to the in-vehicle device so that the support can be started at the desired start time.

In addition, each of the plurality of pieces of support request information includes incentive information given when support is executed. With this arrangement, the vehicle occupant or the like can promote positive support to the support request.

In addition, each of the plurality of pieces of support request information includes information concerning a time for performing support. With this arrangement, a vehicle occupant or the like can appropriately judge whether to support a support request while heading to the destination.

In addition, the reception means further receives, from the information terminal, information indicating whether support can be made for support request information transmitted by the transmission means. With this arrangement, an appropriate countermeasure can be made in accordance with whether the vehicle occupant or the like can respond to the support request.

In addition, the support request apparatus further includes generation means (for example, 228) for generating route information up to a support location if information indicating that support is possible is received from the information terminal, and the transmission means transmits the route information generated by the generation means to the information terminal. With this arrangement, the information terminal can start the route guidance up to the support location for the vehicle occupant or the like.

The present invention is not limited to the above-described embodiments, and various changes and modifications can be made within the spirit and scope of the present invention. Therefore, to apprise the public of the scope of the present invention, the following claims are made.

What is claimed is:

1. A server apparatus for transmitting information for requesting support to an information terminal mounted in a moving object, the apparatus comprising:
a management unit configured to manage a plurality of pieces of information each including a support location;
a reception unit configured to receive current position information of the moving object from the information terminal;
a selection unit configured to select, based on the current position information received by the reception unit, among the plurality of pieces of information, information indicating that a positional relationship between a current position of the moving object and the support location satisfies a predetermined condition; and
a transmission unit configured to transmit the information selected by the selection unit to the information terminal,
wherein the reception unit further receives, from the information terminal, remaining amount information of a battery mounted in the moving object, and
wherein the selection unit selects, as the predetermined condition, among the plurality of pieces of information, information satisfying a condition in which the support location is present in a range of a possible moving distance of the moving object estimated from the remaining amount information.

2. The server apparatus according to claim 1, wherein the selection unit selects, as the predetermined condition, among the plurality of pieces of information, information satisfying a condition in which a moving distance from the current position of the moving object to the support location is not more than a predetermined distance.

3. The server apparatus according to claim 1, wherein the selection unit selects, as the predetermined condition, among the plurality of pieces of information, information satisfying a condition in which a moving time from the current position of the moving object to the support location is not more than a predetermined time.

4. The server apparatus according to claim 1, wherein the selection unit selects, among the plurality of pieces of information, information indicating that a charging station capable of charging the moving object is present in the support location.

5. The server apparatus according to claim 1, wherein the management unit manages, as the plurality of pieces of information, a plurality of pieces of support request information concerning a support request.

6. The server apparatus according to claim 5, wherein the selection unit selects support request information in accordance with desired start time of a support request.

7. The server apparatus according to claim 5, wherein each of the plurality of pieces of support request information includes incentive information given when support is executed.

8. The server apparatus according to claim 5, wherein each of the plurality of pieces of support request information includes information concerning a time for performing support.

9. The server apparatus according to claim 5, wherein the reception unit further receives, from the information terminal, information indicating whether support can be made for support request information transmitted by the transmission unit.

10. The server apparatus according to claim 9, further comprising a generation unit configured to generate route information up to a support location if information indicating that support is possible is received from the information terminal,
wherein the transmission unit transmits the route information generated by the generation unit to the information terminal.

11. The server apparatus according to claim 1, wherein the moving object includes a vehicle, and the information terminal includes an in-vehicle device.

12. A method of transmitting information for requesting support to an information terminal mounted in a moving object, the method comprising:
a reception step of receiving current position information of a moving object from the information terminal;
a selection step of selecting, based on the current position information received in the reception step, among a plurality of pieces of information each including a support location, information indicating that a positional relationship between a current position of the moving object and the support location satisfies a predetermined condition; and
a transmission step of transmitting the information selected in the selection step to the information terminal,
wherein in the reception step, remaining amount information of a battery mounted in the moving object is further received from the information terminal, and
wherein in the selection step, information satisfying a condition in which the support location is present in a range of a possible moving distance of the moving object estimated from the remaining amount information is selected as the predetermined condition among the plurality of pieces of information.

13. A non-transitory computer-readable storage medium storing a program for causing a computer to function as each unit of a server apparatus according to claim 1.
